(19) United States
(12) Patent Application Publication
(10) Pub. No.: US 2019/0191827 A1
(43) Pub. Date: Jun. 27, 2019

(54) Accessory for a Bracelet Watch

(71) Applicant: Mondaine Watch Ltd., Pfaffikon SZ (CH)

(72) Inventor: Andre Bernheim, Meilen (CH)

(73) Assignee: Mondaine Watch Ltd., Pfaffikon SZ (CH)

(21) Appl. No.: 16/293,234

(22) Filed: Mar. 5, 2019

Related U.S. Application Data
(63) Continuation-in-part of application No. 15/454,348, filed on Mar. 9, 2017.

(30) Foreign Application Priority Data
Mar. 10, 2016 (FR) 1651994

(51) Int. Cl. A44C 5/00; G06K 19/077

(52) U.S. Cl. CPC A44C 5/003; G06K 19/07762

(57) ABSTRACT

The invention relates to an accessory (1) for a wristwatch, comprising a housing configured to receive an electronic card in a removable manner.

This application is a continuation-in-part under 35 U.S.C. § 120 of co-pending U.S. patent application Ser. No. 15/454,348, filed on Mar. 9, 2017. This application claims priority under 35 U.S.C. § 119 to French Patent Application No. 1651994, filed on Mar. 10, 2016. The disclosure of these applications is incorporated herein by reference.

### TECHNICAL FIELD OF THE INVENTION

The present invention relates to an accessory for a wristwatch configured for receiving an electronic card in a removable manner. The accessory may form a band of a wristwatch or, alternatively a loop of a wristwatch band.

### BACKGROUND OF THE INVENTION

In the horology field, more specifically in the field of wristwatches, today there is a specific category of so-called “connected” watches. These watches, in addition to providing the usual information regarding the passing of time, provide all types of functionalities, in particular communication and/or contactless payment functions. These functionalities are generally implemented using electronic modules built and configured specifically, which are generally an integral part of the mechanism of the watch, which is generally housed in the case thereof. However, since these communication and/or contactless payment functionalities are completely dependent on the presence of the electronic modules that provide them, and since these watches are generally not adapted for it to be possible to remove these electronic modules temporarily, a user must therefore wear his specific watch at all times if he wishes to benefit from these functionalities. Likewise, a user who owns a connected watch providing communication or contactless payment functionalities through specific electronic modules generally cannot extend these functionalities to another watch in his collection.

U.S. Pat. No. 6,412,976 discloses a wristwatch comprising a first part of a strap embedding an electronic device such as a tag or microchip and antenna for authentication purposes. The electronic device is permanently inserted in the part of the strap between two layers of leather between the seams of near the watch. The part of the strap has no orifice for insertion or removal of the device.

US2014110445 relates to a band capable of substantially surrounding a limb, neck, or head of a user, the band comprising: a main portion capable of substantially surrounding a limb, neck, or head of a user; and a pocket provided within the main portion, wherein the pocket includes a slit whereby an entrance to an interior of the pocket is provided which is capable of removably storing at least one item placed within the interior of the pocket via the slit wherein at least a portion of the pocket that includes the slit is stretchable.

### BRIEF DESCRIPTION OF THE INVENTION

The invention aims to offset these drawbacks.

In particular, the invention aims at providing an accessory for a wristwatch configured for inserting or receiving in a removable manner an electronic card within the accessory so that the card can be easily removed by the user.

Another aim of the invention is to provide an accessory for a wristwatch configured for receiving or inserting in a removable manner an electronic card adapted to any watch and being able to be transferred without particular difficulty from one watch to another.

These aims are achieved by an accessory according to the appended claims.

In one embodiment of the invention, the accessory is a wristwatch band.

The wristwatch band of the invention comprises a first band part and a second band part; wherein the first band part has a longitudinal direction and a transversal direction and comprises a non-expandable housing comprising an internal storage volume configured to receive an electronic card, wherein the housing is made of non-stretchable material;

wherein the housing further comprises:
a first orifice having the form of a slit opened to the outside of the housing, communicating with the internal storage volume, and sized to accept insertion of the electronic card into the internal storage volume along a direction of the insertion, such that the electronic card can be housed in the housing in a removable manner; and,
a second orifice smaller than the first orifice and sized to prevent the device from exiting the volume in the direction of insertion and communicating with the internal storage volume of the housing,
   wherein the second orifice is located on the housing in the direction of insertion at a distance from the first orifice, wherein the second orifice is shaped to admit a pointy object to apply a force in a direction opposite the direction of insertion to remove the electronic card from the housing without damaging the accessory and without modifying the structure of the band.

In particular, the material (s) for the housing may be chosen amongst leather, fabrics, cork, metal, plastic and combinations thereof. The first orifice has preferably a longest dimension extending perpendicular to the direction of insertion. The housing is preferably formed of at least two layers, respectively an inner layer and an outer layer, which are superimposed and selectively connected to delimit the internal storage volume of the housing. The slit is preferably provided through the inner layer. The inner layer is the one intended to be in contact with the wrist of the user when the wristwatch is worn. The second orifice is elongated with its longest dimension extending in the insertion direction. The second orifice may be oblong or rectangular. The second orifice has preferably a longer dimension between 2 and 15 mm and a shorter dimension between 0.5 and 2.5 mm. The housing is preferably configured so that the longitudinal direction corresponds to the insertion direction and the transversal direction is perpendicular to the insertion direction.

In another embodiment of the invention, the accessory is a loop for a wristwatch.

The loop-type accessory comprises an upper wall and at least one ring; wherein the upper wall comprises a housing comprising an internal storage volume configured to receive an electronic card,

wherein the housing comprises:
a first orifice having the form of a slit opened to the outside of the housing, communicating with the internal storage volume, and sized to accept insertion of the electronic card into the internal storage volume along a direction of the insertion, such that the electronic card can be housed in the housing in a removable manner; and,
a second orifice smaller than the first orifice and sized to prevent the device from exiting the volume in the direction of insertion and communicating with the internal storage volume of the housing,
   wherein the second orifice is located on the housing in the direction of insertion at a distance from the first orifice,
   wherein the second orifice is shaped to admit a pointy object to apply a force in a direction opposite the direction of insertion to remove the electronic card from the housing without damaging the accessory and without modifying the structure of the accessory.

In this embodiment, the accessory may be formed of a stretchable and resilient material or, alternatively, of non-extendable material. In particular, the stretchable and resilient material for the accessory may be synthetic rubber, natural rubber, silicone, thermoplastic elastomer and combinations thereof. In particular, the non-extendable material (s) for the accessory may be chosen amongst leather, fabrics, cork, metal, plastic and combinations thereof.

The first orifice has preferably a longest dimension extending perpendicular to the direction of insertion.

In this embodiment, the second orifice has preferably a substantially circular cross-section. The second orifice has a diameter comprised between 0.4 and 3 mm.

In this embodiment, the housing is preferably configured so that the longitudinal direction of the housing corresponds to the insertion direction and the transversal direction is perpendicular to the insertion direction.

Preferably, the upper wall is cuboid. The internal storage volume of the housing is also preferably cuboid. It may also be a truncated cuboid to match a complementary shape of the electronic card.

In this embodiment, the loop-type accessory may comprise two rings connected to the upper wall to the longitudinal ends of the upper wall and being distant one another by a U-shaped free space. Each ring may comprise a transversal through-passage. The through-passage is dimensioned to match the band of a watch. The ring may be stretchable to adjust to different widths of bands. For example, this is the case when the accessory is formed of a stretchable and resilient material.

In a possible aspect, the ring(s) has (have) a non-rectilinear transversal portion for allowing the loop to be deformed and to adjust to different widths of wristwatch bands.

In a possible aspect, the second orifice has a cutout. The housing has an upper surface and a lower surface. The lower surface is the surface which faces towards the ring(s) and the upper surface is the opposite surface. The cutout is preferably provided on the lower surface of the housing so that the band of the watch covers it in use. The cutout may also be provided on the upper surface of the housing.

In the present application, the terms “electronic card” refer to a wireless electronic device in the form of a rigid or flexible card with an electronic circuit printed or attached thereon (e.g. a chip card) which can communicate information to an electronic receiving device. The device can for instance provide authentication, access or entry functions e.g. to a gate, entry, trains, fitness center, sport event, etc., or provides contactless payment function or provide other communication functionalities such as GPS or others.

### BRIEF DESCRIPTION OF THE FIGURES

Other features and advantages of the invention will emerge from reading the following description, in reference to the appended figures, which illustrate:

FIG. 1, a perspective view of an independent loop-type accessory for a watch band according to an embodiment of the invention;

FIG. 2, a perspective opposite view of the independent loop-type accessory for a watch band of FIG. 1 when a planar rotation of 180° (angle degrees) of the accessory shown in FIG. 1 has been done;

FIG. 3, a perspective view of a wristwatch band according to the invention;

FIG. 4, is a cross section view of the independent loop-type accessory according to the embodiment of FIGS. 1 and 2 along plan A-A of FIG. 2; and

FIG. 5, is a cross section view of an accessory taking the form of a watch wrist band according to the embodiment of FIG. 3 along plan B-B of FIG. 3.

FIG. 6 shows a picture of a variant of the independent loop-type accessory;

FIG. 7 shows a picture of a variant of a part of the wristwatch band of the invention.

### DETAILED DESCRIPTION OF THE INVENTION

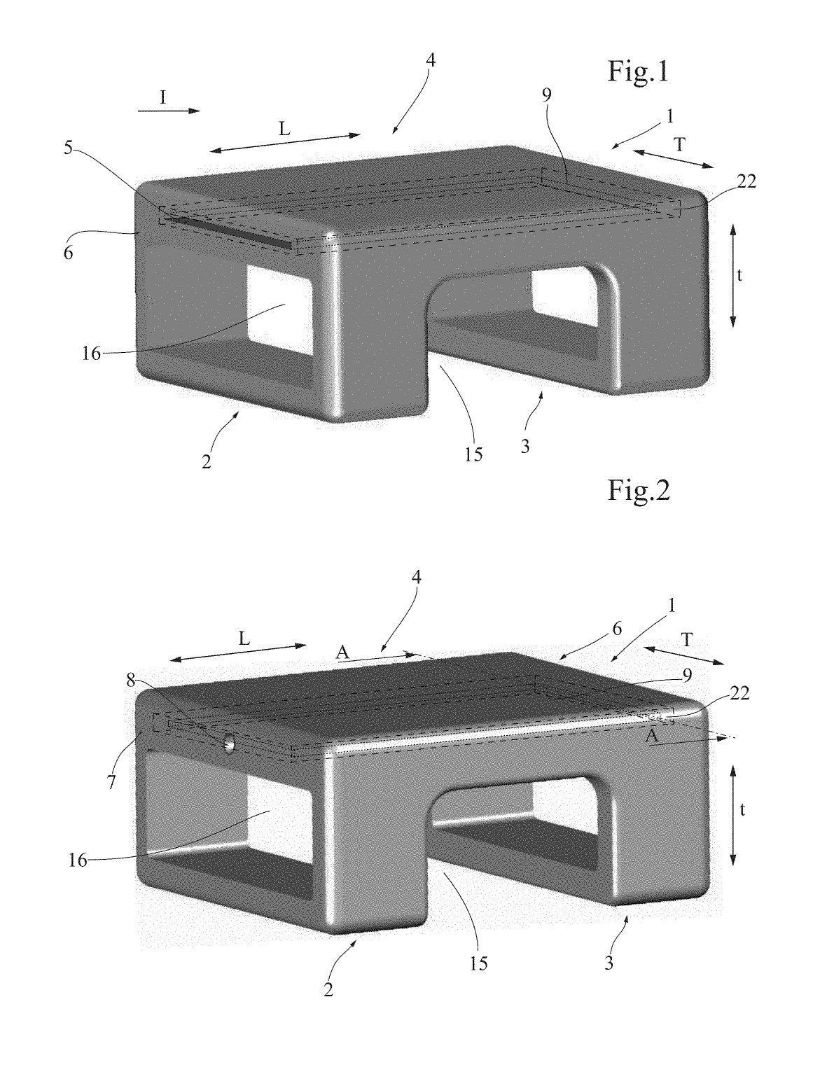

FIG. 1 shows a perspective view of an independent loop-type accessory 1 for a wristwatch according to a preferred embodiment of the invention. According to this embodiment, the loop-type accessory 1 forms a loop that comprises two rings 2, 3 that together share an upper wall part 4. The upper wall has a substantially cuboid shape. The upper wall part extends, e.g. by its longer length, in a longitudinal direction L of the accessory. The rings 2, 3 connect to the longitudinal ends of the upper wall and are distant one another by a U-shaped free space 15. Each ring comprises a transversal through-passage 16, e.g. of rectangular shape, for allowing a band part of a wristwatch to be received or passed. The rings are especially formed in order that they can expand, which makes the loop suitable for fitting onto different width and/or thicknesses of bands

Within the upper wall part 4 of the accessory 1, a housing is formed that defines an internal storage volume 22 suitable for receiving an electronic card 9. Thus, the internal storage volume 22 of the housing found within the upper wall part 4 is preferably also substantially cuboid but may have other three-dimensional shapes complementary to the form of the electronic card intended to be received.

The housing comprises a first orifice 5 which opens the internal volume to the outside of the loop-type accessory 1, advantageously allowing the insertion of the electronic card. The first orifice 5 communicates with the internal storage volume 22 of the housing. The first orifice 5 preferably defines a slit at a first longitudinal end face 6 of the accessory. The slit may be of rectangular cross-section. The length of the slit extends in the transversal direction T of width the upper wall and the thickness of the slit 5 extends in the direction t of the thickness of the upper wall. The length of the slit is slightly larger than the width of the electronic card. For example, in the transversal direction T, the length of the slit is comprised between 1 and 3 cm. In the thickness direction t, the thickness of the slit is also slightly larger than the thickness of the electronic card. For example, the thickness of the slit may be comprised between 0.8 and 2.5 mm.

The shape of the first orifice 5 can alternatively be adapted to match another shape of the electronic card.

The loop-type accessory can be made of resilient material(s) or alternatively a non-extendable material(s). The resilient material(s) can be chosen amongst synthetic rubber, natural rubber, silicone, thermoplastic elastomer and combinations thereof. The non-extendable material can be chosen amongst: leather, metal, wood, fabrics, fiberglass, carbon composite, plastic and combinations thereof.

FIG. 2 shows a perspective view of the accessory 1 when a planar rotation of 180° (angle degrees) of the accessory 1 shown in FIG. 1 has been done. In other words, FIG. 2 shows, on the left, the end face 7 of the accessory 1 opposite the face 6. The housing comprises a second orifice 8 located at the second longitudinal end face 7 of the upper wall. The first orifice 5 is located opposite the first orifice and in the extension of the direction of insertion I of the electronic card. The second orifice 8 has a cross-section smaller than the first orifice 5. The second orifice 8 is smaller than the cross-section of the electronic card to not allow the card to be removed accidentally through the second end face 17. Preferably, the second orifice has a diameter comprised between 0.4 and 3 mm. When an electronic card is housed in the internal volume 22 of the housing, the user can remove the card from the housing by applying pressure in with a pointed objet through the second orifice 8.

The orifice 8 is so configured to allow the insertion of a pointy object, such as a needle, tip, punch or any other small rigid pointy object capable of being inserted through the orifice. When an electronic card is present in the housing, the pointed object traversing the second orifice 8 pushes the card outside the housing through the first orifice 5. Once the card protrudes sufficiently from the first orifice or slit 5, the card can be handled by the user for completing its removal from the housing. The card can be pushed completely out of the housing by the pointed object if the latter is designed appropriately.

Although FIGS. 1 and 2 show a loop-type accessory 1 which has two rings, the accessory 1 may alternatively have only one ring or more than two rings. One skilled in the art will understand that as for the previous mode, the housing can be provided with the two opposite orifices 5, 8 which may be provided on the end faces of the loop comprising only one ring or a loop including more than two rings. Furthermore, although the previous embodiment shows a housing extending in the length of the accessory, the housing may alternatively extend in the width of the accessory. In the second case, the orifices are for example provided on the two lateral faces of the upper wall of the accessory.

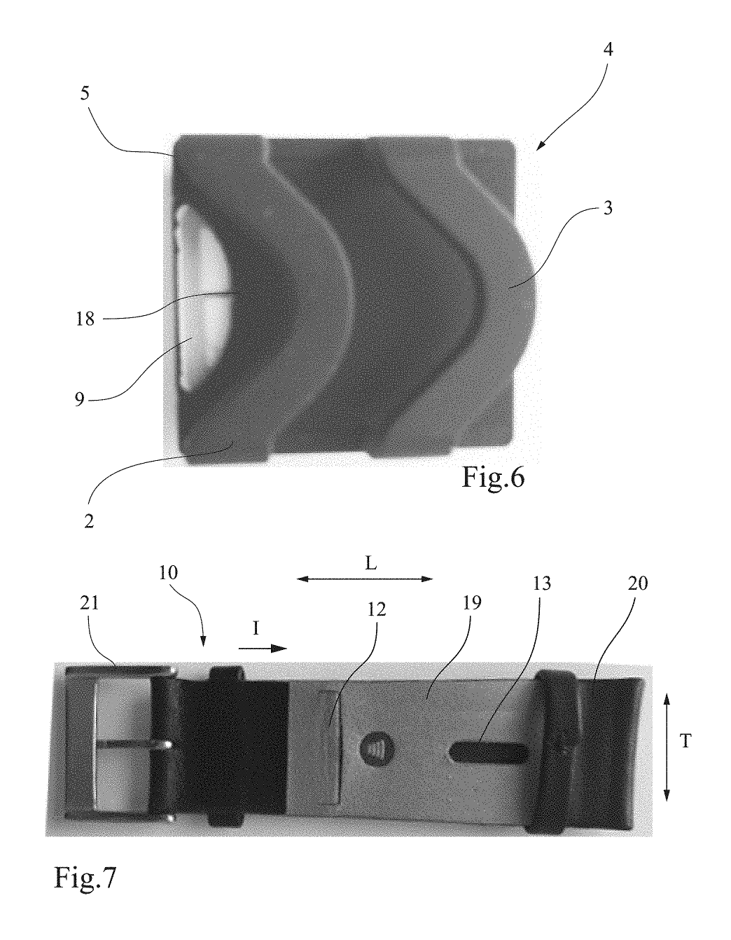

As illustrate in FIG. 6, the slit may further be provided with a cutout 18 provided on one of the upper or lower surfaces of the upper wall 5. Preferably, the cutout is provided in the lower surface of the upper wall so that the band of the wristwatch covers it during use. When the electronic card 9 is inserted in the internal storage volume of the housing, a part of the card may remain visible through the cutout 18. As a result, the cutout 18 can help remove the card more easily by facilitating access to the card. The first rings 2, 3 of the loop-type accessory may have non-rectilinear transversal portions, such as of concave or wave shape, to allow the ring to be stretched and to fit to many different watches with different strap width.

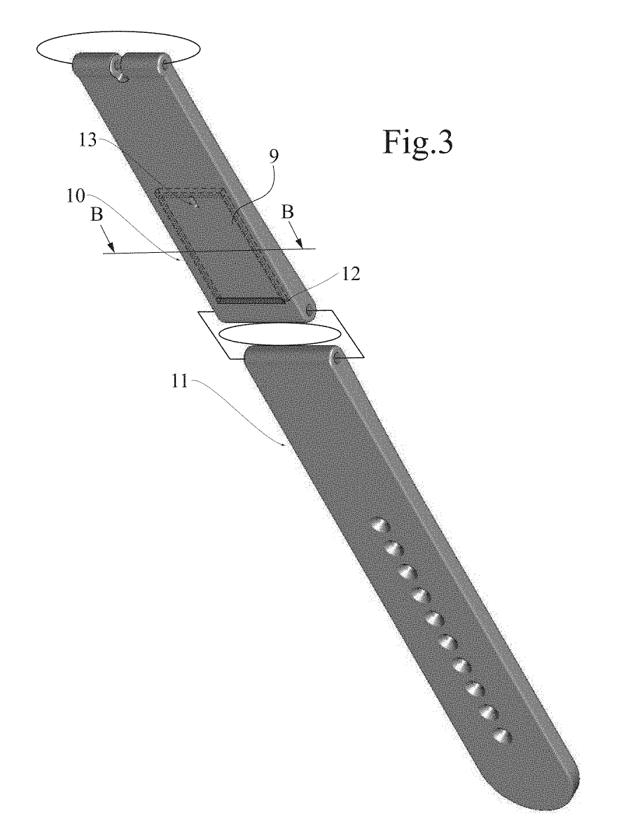

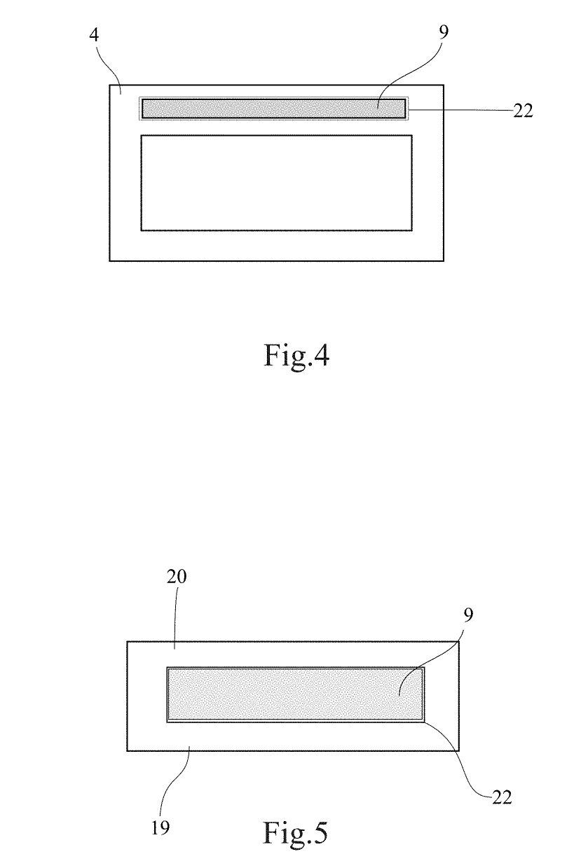

According to a second embodiment of the invention, shown in FIGS. 3, 5 and the example of FIG. 7, the accessory 10 forms a watch band, which, in the usual manner, comprises a short band part 10 and a second longer band part 11. Each of the two band parts 10, 11 is attached to a wristwatch. The short band part 10 may comprise a pin buckle for its attachment to the opposite end of the longer band part 11. As in the previous embodiment described above, a housing is formed within the first band part 10. The housing defines an internal storage volume 22 suitable for receiving an electronic card 9. The housing is provided with a first orifice 12 that defines a slit through which the electronic card 9 can be inserted inside the housing. The slit preferably extends in transversal direction of the band. The slit is preferably provided on the inner surface of the band part which is intended to be in contact with the wrist. As a result, the card is prevented from any unintended removal. Alternatively, the slit can be provided on the outer surface opposite the inner surface of the band part. The slit communicates with the internal storage volume 22 of the housing. The slit is preferably provided at one first longitudinal end of the housing 9. The shape of the first orifice 12 can alternatively be adapted to match another shape of the electronic card. The housing for the electronic card can also be provided in the longer band part 11.

The housing is further provided with a second orifice 13 opening the housing to the outside of the accessory 10. The second orifice 13 is configured to allow the insertion of a pointy object, e.g. a tip of a pen or key, a needle or the like, and thus facilitate the removal of the electronic card located inside the housing. Preferably, the second orifice 13 has an oblong or circular shape. Alternatively, the second orifice has a rectangular, square or triangular shape. Preferably, the second orifice 13 has an elongated shape with a longest dimension extending in the longitudinal direction of the band. The longitudinal direction L corresponds to the direction of insertion I of the device. The orifice 13 communicates with the internal storage volume 22. In the preferred example, the orifice is positioned at one second longitudinal end opposite to the first longitudinal end of the housing. The elongated shape of the orifice can be oblong, rectangular or any similar shape. Preferably, the orifice has a transversal or shorter dimension or width between 0.5 and 2.5 mm and a longitudinal or longer dimension or length between 2 and 15 mm.

The first watch band is made of non-extendable or non-stretchable material. As a result, the size of the orifices of the band does not expand when the card is removed.

In particular, the material(s) of the band can be chosen amongst leather, metal, plastic (e.g. synthetic leather), fabrics, cork, other natural non-stretchable materials, and combinations thereof.

As illustrated as an example in FIG. 7, the wristwatch band part 10 is essentially made of leather. The housing is formed of at least two layers 1, respectively an inner layer 19 and an outer layer 20, which are superimposed and selectively connected, e.g. glued and/or sewed, to delimit the internal storage volume of the housing.

Although FIGS. 3 and 7 show the orifices 12, 13 provided on one face of the band 11, these orifices can of course also be provided on the opposite face of the band.

An advantage imparted by a wristwatch band according to the invention is the ability for a consumer to use the wristwatch band housing the electronic card for communicating information with an electronic receiver or other device and to be able to easily remove the electronic card when necessary, such as for disposal or for replacement. Another major advantage of the invention is the possibility given to place the accessory on any watch band—as well as on any jewelry bracelet, a belt, a shoulder strap, a purse strap, etc. The accessory formed as a wristwatch band can also replace any standard wristwatch band. Thus, by using an accessory according to the invention, a user may transfer all the functionalities imparted by the electronic card (e.g. for payment or key functions) from one watch to any other.

Another advantage imparted by the accessory as a loop or the wristwatch band according to the invention is that it is adapted so that both the insertion and removal of the electronic card into or out of the accessory can be done without damaging the accessory and without having to modify its structure, even temporarily. The accessory according to the invention therefore allows the user to choose the periods during which he wishes to wear the electronic card and without him having to decide not to wear the watch if he does not wish to carry such a device. On this point, the accessory according to the invention therefore allows the user complete freedom of choice. The invention also is also useful for parents who want to allow their children temporarily to carry a payment or entry device with them.

1. A wristwatch band with a first band part and a second band part;
wherein the first band part has a longitudinal direction and a transversal direction and comprises a non-expandable housing comprising an internal storage volume configured to receive an electronic card,
wherein the housing is made of non-stretchable material;
wherein the housing comprises:
a first orifice having the form of a slit opened to the outside of the housing, communicating with the internal storage volume, and sized to accept insertion of the electronic card into the internal storage volume along a direction of the insertion, such that the electronic card can be housed in the housing in a removable manner; and,
a second orifice smaller than the first orifice and sized to prevent the device from exiting the volume in the direction of insertion and communicating with the internal storage volume of the housing,
wherein the second orifice is located on the housing in the direction of insertion at a distance from the first orifice,
wherein the second orifice is shaped to admit a pointy object to apply a force in a direction opposite the direction of insertion to remove the electronic card from the housing without damaging the accessory and without modifying the structure of the band.

2. The wristwatch band according to claim 1, wherein the material (s) for the housing is chosen amongst leather, fabrics, cork, metal, plastic and combinations thereof.

3. The wristwatch band according to claim 1, wherein the first orifice has a longest dimension extending perpendicular to the direction of insertion.

4. The wristwatch band according to claim 3, wherein the housing is formed of at least two layers, respectively an inner layer and an outer layer, which are superimposed and selectively connected to delimit the internal storage volume of the housing.

5. The wristwatch band according to claim 4, wherein the slit is provided through the inner layer.

6. The wristwatch band according to claim 1, wherein the second orifice is elongated with its longest dimension extending in the insertion direction.

7. The wristwatch band according to claim 6, wherein the second orifice is oblong or rectangular.

8. The wristwatch band according to claim 7, wherein the second orifice has a longer dimension between 2 and 15 mm and a shorter dimension between 0.5 and 2.5 mm.

9. The wristwatch band according to claim 1, wherein the housing is configured so that the longitudinal direction of the housing corresponds to the insertion direction and the transversal direction is perpendicular to the insertion direction.
